(19) United States
(12) Patent Application Publication
(10) Pub. No.: US 2017/0313468 A1
(43) Pub. Date: Nov. 2, 2017

(54) FACIAL TISSUE PAPER PLUMAGE CONTROL APPARATUS

(71) Applicant: Brandon Vern Kadar, Fullerton, CA (US)

(72) Inventor: Brandon Vern Kadar, Fullerton, CA (US)

(21) Appl. No.: 15/140,592

(22) Filed: Apr. 28, 2016

(51) Int. Cl. B65D 5/44; B65D 5/76; B65D 5/72; F16M 13/02; B65D 5/42

(52) U.S. Cl. CPC B65D 5/448; F16M 13/022; B65D 5/4295; B65D 5/727; B65D 5/76

(57) ABSTRACT

The invention is for an apparatus that provides a form above the box to shape the tissue paper plumage.

I, Brandon Vern Kadar, have invented a facial tissue paper plumage control apparatus as set forth in the following specification. The claimed facial tissue paper plumage control apparatus is used for shaping facial tissue paper.

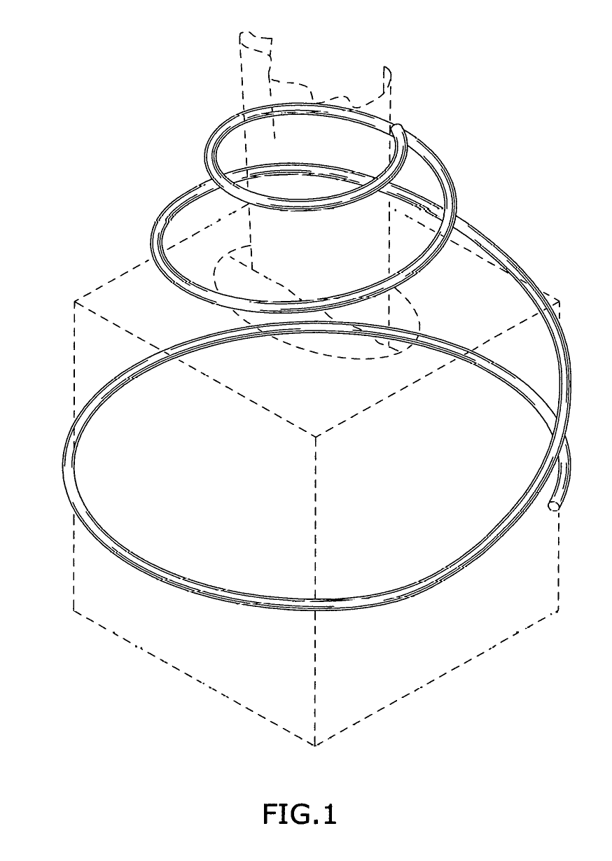

FIG. 1: is a top front perspective view the apparatus, showing a wire form attached to a standard facial tissue box and shaping the tissue paper plumage;

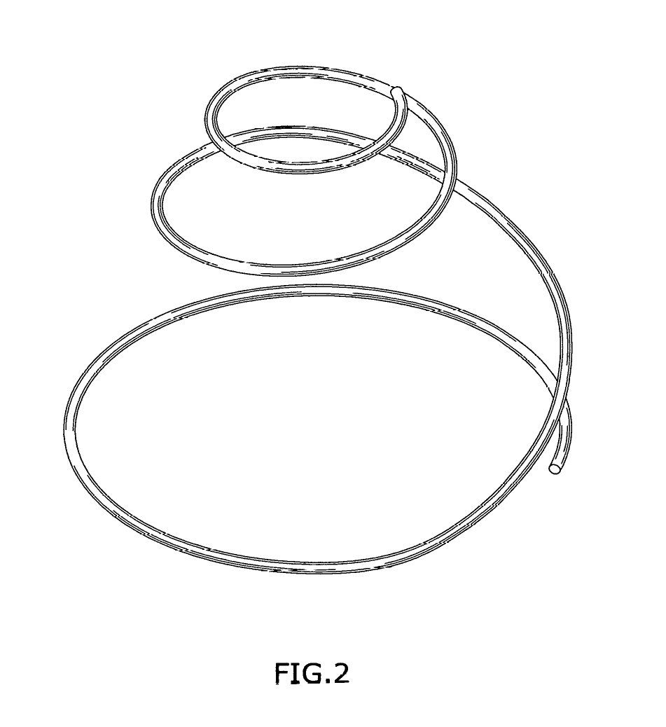

FIG. 2: is a top front perspective view the apparatus;

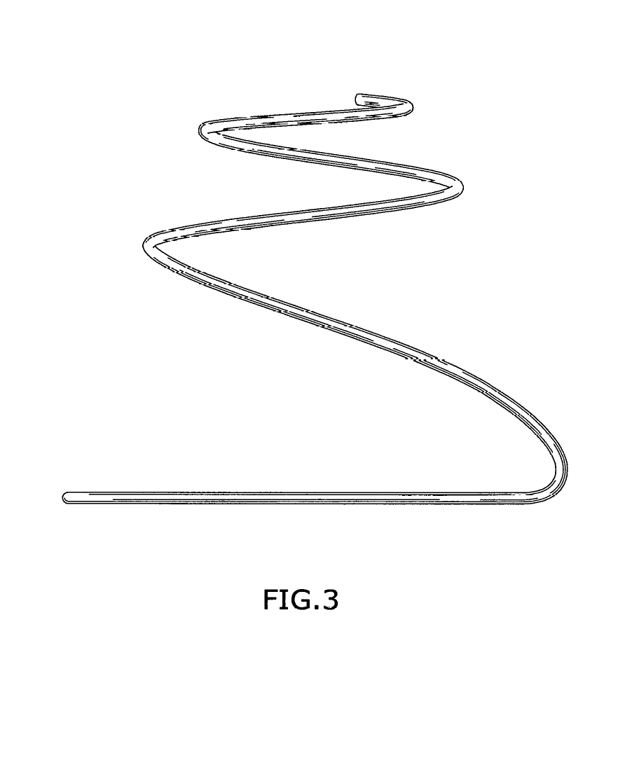

FIG. 3: is a front elevation view thereof;

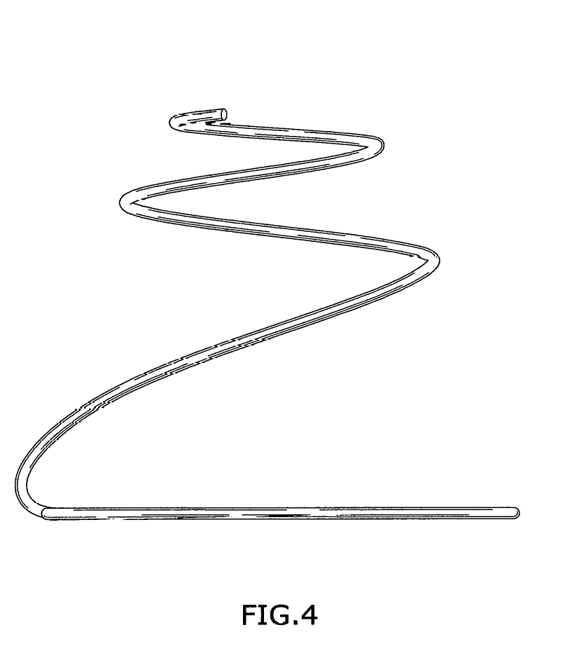

FIG. 4: is a rear elevation view thereof;

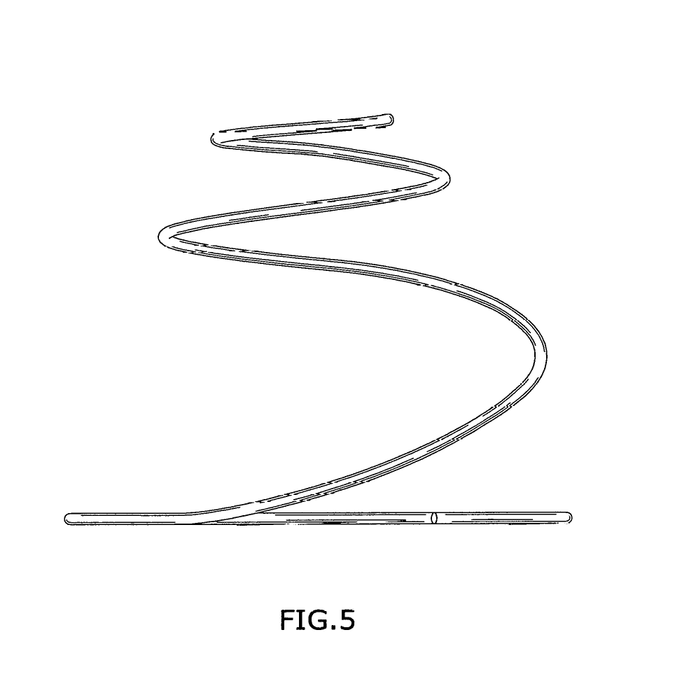

FIG. 5: is a right elevation view thereof;

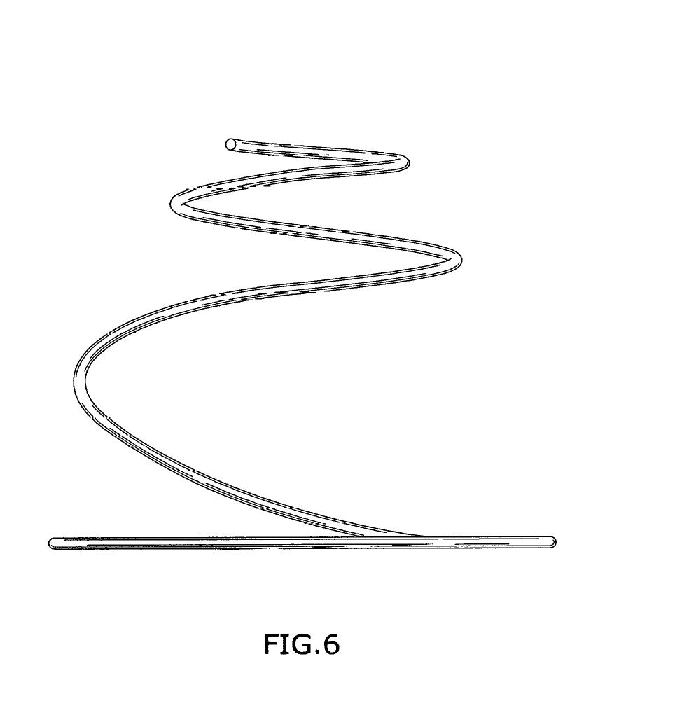

FIG. 6: is a left elevation view thereof;

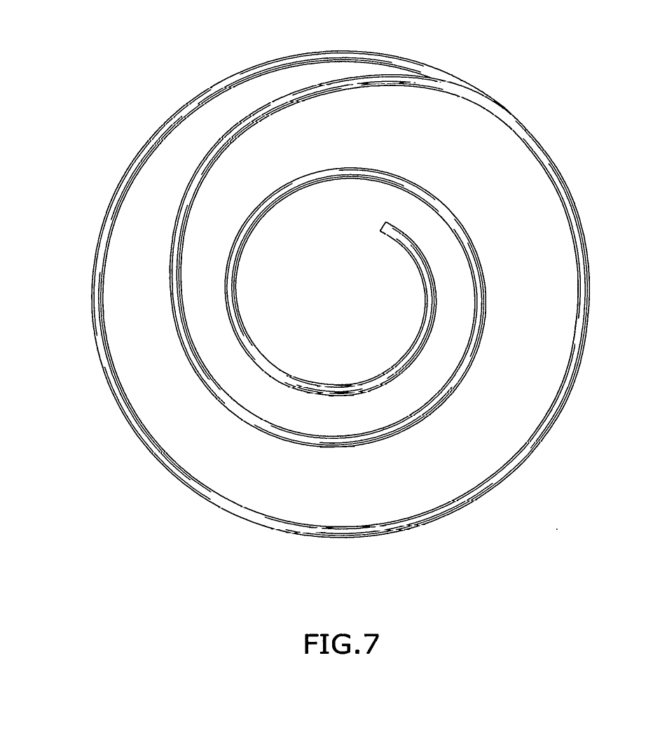

FIG. 7: is a top elevation view thereof;

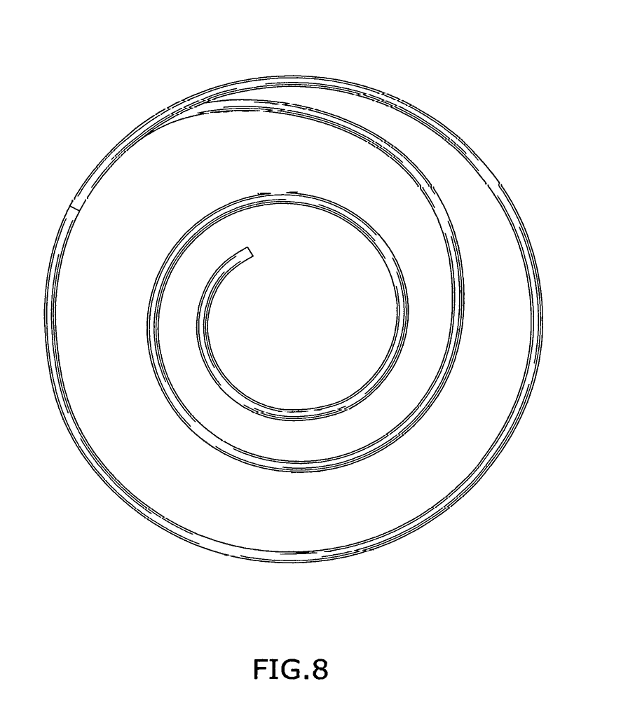

FIG. 8: is a bottom elevation view thereof.

### FIELD OF INVENTION

The present invention relates to standard facial tissue boxes and tissue plumage shaping.

### BACKGROUND OF INVENTION

Standard facial tissues are folded and arranged in a box in a way that allows the pulling of one tissue paper to result in the next tissue paper to pop out of the box. The resulting tissue paper plumage is many times unruly and aesthetically displeasing.

### SUMMARY OF INVENTION

The present invention shapes tissue paper plumage. The user attaches the apparatus to the tissue box. Next, the user pulls a tissue through the wire form above the box. The subsequent tissue paper comes into contact with the wire that acts as a guide and forming point. The resulting tissue paper plumage is confined to a shape area, thus, solving the problem of unruly and aesthetically displeasing tissue paper plumage.

Cross-reference to related design application: 29562516 Facial Tissue Paper Plumage Control Apparatus.

Cross-reference to related design application: 29562579 Facial Tissue Paper Box Stand Plumage Control Apparatus.

What is claimed is:

1. An apparatus that shapes facial tissue paper plumage.
A wire form that attaches to a tissue box and provides a form above the box to shape the facial tissue paper plumage.
